(19) United States
(12) Patent Application Publication
(10) Pub. No.: US 2025/0322603 A1
(43) Pub. Date: Oct. 16, 2025

(54) BUNDLE ADJUSTMENT IN SIMULTANEOUS LOCALIZATION AND MAPPING

(71) Applicant: Google LLC, Mountain View, CA (US)

(72) Inventors: Thomas Friel Allen, El Cerrito, CA (US); Chao Guo, Los Altos, CA (US); Esha Dattaram Nerurkar, Los Altos Hills, CA (US); Yong-Dian Jian, Campbell, CA (US)

(21) Appl. No.: 19/180,816

(22) Filed: Apr. 16, 2025

Related U.S. Application Data
(60) Provisional application No. 63/634,695, filed on Apr. 16, 2024.

(51) Int. Cl. G06T 17/00; G06T 7/246; G06T 7/70

(52) U.S. Cl. CPC G06T 17/00; G06T 7/246; G06T 7/70

(57) ABSTRACT

A method including identifying a landmark in image data captured by a device, receiving pose data associated with the image data, determining that the landmark is included in a map of an environment, and in response to determining that the landmark is included in the map, determining that a timestamp associated with the image data meets a criterion, and in response to the device determining that the timestamp meets the criterion, modifying the map based on the landmark and the pose data.

### CROSS REFERENCE TO RELATED APPLICATION

This application claims priority to U.S. Provisional Patent Application No. 63/634,695, filed on Apr. 16, 2024, entitled “BUNDLE ADJUSTMENT COMPUTE TIME BY OPTIMIZING ONLY RECENTLY OBSERVED LANDMARKS”, the disclosure of which is incorporated by reference herein in its entirety.

### BACKGROUND

Simultaneous Localization and Mapping (SLAM) is a technology for robots and/or augmented reality (AR) applications, enabling the robot and/or AR applications to navigate and interact with their environments. SLAM includes simultaneously building a map of an unknown environment (mapping) while determining its own location within that map (localization). SLAM algorithms utilize data from various sensors like cameras, lidar (light detection and ranging), radar, and inertial measurement units (IMUs) to perceive the environment and estimate the device's motion. These algorithms process the sensor data to identify unique features or landmarks in the environment and track how these features move relative to the device over time.

### SUMMARY

Keyframing is a technique that selects specific frames to optimize the SLAM process. Keyframing can reduce computational demand. Bundle adjustment in keyframing is used to refine or modify a map (e.g., three-dimensional (3D) map), data associated with the map, and/or camera poses. Example implementations reduce bundle adjustment resource utilization (e.g., costs) by selectively modifying (sometimes called freezing) landmarks based on the recency of observations of those landmarks. In some implementations, selectively modifying a landmark (or data representing a landmark) can reduce the quantity of data used in bundle adjustment.

In a general aspect, a device, a system, a non-transitory computer-readable medium (having stored thereon computer executable program code which can be executed on a computer system), and/or a method can perform a process with a method including identifying a landmark in image data captured by a device, receiving pose data associated with the image data, determining that the landmark is included in a map of an environment, and in response to determining that the landmark is included in the map, determining that a timestamp associated with the image data meets a criterion and/or criteria, and in response to the device determining that the timestamp meets the criterion and/or criteria, modifying the map based on the landmark and the pose data.

In another general aspect, a device, a system, a non-transitory computer-readable medium (having stored thereon computer executable program code which can be executed on a computer system), and/or a method can perform a process with a method including determining a device motion using a first plurality of landmarks and device poses, selecting a second plurality of landmarks, the second plurality of landmarks including a subset of the first plurality of landmarks, the second plurality of landmarks surrounding a current device location, and updating map data of a map of an environment based on the second plurality of landmarks and the device poses.

In yet another general aspect, a device, a system, a non-transitory computer-readable medium (having stored thereon computer executable program code which can be executed on a computer system), and/or a method can perform a process with a method including determining an environment lacks an associated map, traversing the environment by a device, identifying a landmark in first image data captured by a device, receiving pose data associated with the first image data, determining the device has previously received second image data associated with a current location of the device within the environment, and in response to determining the device has received the second image data, discard data associated with the landmark and the pose data.

### BRIEF DESCRIPTION OF THE DRAWINGS

Example implementations will become more fully understood from the detailed description given herein below and the accompanying drawings, wherein like elements are represented by like reference numerals, which are given by way of illustration only and thus are not limiting of the example implementations.

FIG. 1 illustrates a system for traversing a real-world environment using a map according to an example implementation.

FIG. 2 illustrates a block diagram of a signal flow for bundle adjustment according to an example implementation.

FIG. 3A illustrates a plurality of circles that denote device poses from a starting time instant 1 to a current time instant 10 according to an example implementation.

FIG. 3B illustrates a plurality of circles that denote device poses from a starting time instant 1 to a current time instant 10 according to an example implementation.

FIG. 4 illustrates a block diagram of a first phase sometimes referred to as location learning according to at least one example implementation.

FIG. 5 illustrates a block diagram of a method for location learning according to at least one example implementation.

FIG. 6 illustrates a block diagram of a second phase sometimes referred to as feature dataset recording according to at least one example implementation.

FIG. 7 illustrates a block diagram of a method for feature dataset recording according to at least one example implementation.

FIG. 8 is a block diagram of a method modifying a map of an environment according to an example implementation.

FIG. 9 is a block diagram of a method modifying a map of an environment according to an example implementation.

FIG. 10 is a block diagram of a method generating a map of an environment according to an example implementation.

It should be noted that these Figures are intended to illustrate the general characteristics of methods, and/or structures utilized in certain example implementations and to supplement the written description provided below. These drawings are not, however, to scale and may not precisely reflect the precise structural or performance characteristics of any given implementation and should not be interpreted as defining or limiting the range of values or properties encompassed by example implementations. For example, the positioning of modules and/or structural elements may be reduced or exaggerated for clarity.

The use of similar or identical reference numbers in the various drawings is intended to indicate the presence of a similar or identical element or feature.

### DETAILED DESCRIPTION

Devices and/or applications executing on a device can traverse (e.g., move within) a real-world environment using a map of the real-world environment. The map can include a landmark(s). The landmark can be an object in the real-world environment. The landmark can be a stationary object. For example, the landmark can be a desk, a building, a wall, a tree, and the like. However, a landmark may not be a car, a person, an animal, and the like. In other words, a landmark may not be an object that moves often. An application executing on the device can be used to retrieve the map from a memory location. An application executing on the device can be used to collect data (sometimes called map data) to generate a map and/or modify a map. The data collection can include data corresponding to the location associated with the real-world data. The data collection can include data corresponding to the landmark(s). The data collection can include data corresponding to a pose or pose data (e.g., orientation, rotation, and the like) of the device.

SLAM is technology for devices including, for example, robots, drones, and computing devices (including wearable devices) executing augmented reality (AR) applications to navigate and understand their surroundings. SLAM builds a map of the environment while simultaneously locating the device within that map. Keyframes, which are images of the real-world environment at key points in SLAM. Keyframing can be a technique configured to select specific images or frames to optimize the SLAM process which can reduce computational demand of the SLAM on the device.

At least one technical problem with keyframing can be that keyframing can challenge the capabilities of the device with resource-intensive bundle adjustment. Bundle adjustment is used to modify or refine the map (e.g., 3D map), data associated with the map, and/or camera poses. At least one technical problem can be that solving bundle adjustment quickly can be difficult for computing devices with limited processing power (e.g., phones, headsets), and for real-time applications, such as robot and/or drone navigation. Implementations address the technical problems of maintaining reasonable solve times for bundle adjustment in SLAM, enabling efficient and accurate operation in resource-constrained environments and real-time applications.

Existing techniques for SLAM bundle adjustment primarily focus on optimizing only temporally recent keyframes or those within a spatial neighborhood of the current position. Some approaches employ sliding window optimization, where only a fixed window of recent frames is considered, significantly reducing the problem size for bundle adjustment. However, at least one technical problem with this technique is that the technique can lead to inconsistency and drift over time, as older landmarks and their associated constraints are completely ignored.

Other methods utilize local bundle adjustment, optimizing only landmarks and keyframes within a local region around the current position. While this technique can reduce computational burden, at least one technical problem with this technique can be that the technique can suffer from limited global consistency, potentially introducing inaccuracies in the map and pose estimates. Additionally, marginalization techniques attempt to remove the influence of older keyframes by integrating their information into the optimization of remaining points. However, at least one technical problem with marginalization can be that marginalization can be computationally expensive and introduces additional complexity to the SLAM system.

Accordingly, at least one technical problem with existing methods can be that the existing methods fail to fully address the challenge of balancing accuracy, consistency, and computational cost. The existing methods often sacrifice global consistency for speed, leading to potential drifting and inaccuracies in the map or modified map. Additionally, marginalization techniques can themselves be computationally expensive, negating the speed benefits of excluding older keyframes.

At least one technical solution is a method for reducing bundle adjustment costs by selectively modifying landmarks based on the recency of observations of those landmarks. Selectively modifying a landmark can reduce the number of parameters in bundle adjustment. At least one technical effect can be that selectively modifying a meaningful portion of the observed landmarks can substantially reduce the number of parameters in the bundle adjustment problem and significantly improves computation time. Selectively modifying a meaningful portion of the observed landmarks can reduce the number of parameters because the number of landmarks is typically much larger than the number of keyframe poses.

In some implementations, decisions associated with selectively modifying landmarks can be made by considering all, most, substantially all keyframes which observe (e.g., includes) that landmark and selectively modifying those landmarks where the timestamp of the keyframe that observes (e.g., includes) the landmark most recently is older than some time threshold. Selectively modifying landmarks can be based on a criterion and/or criteria. The criterion and/or criteria can be based on the timestamp. The criterion and/or criteria can be based on the timestamp being older than some time threshold. This technique can optimize recently observed landmarks, which are the most likely to benefit from optimization. Further, selectively preserving (e.g., not modifying) landmarks which are unlikely to benefit from optimization, can save computation time with limited effect on the accuracy of landmark positions and keyframe poses. This technique can be used in conjunction with full optimization under certain conditions to further reduce any accuracy degradation.

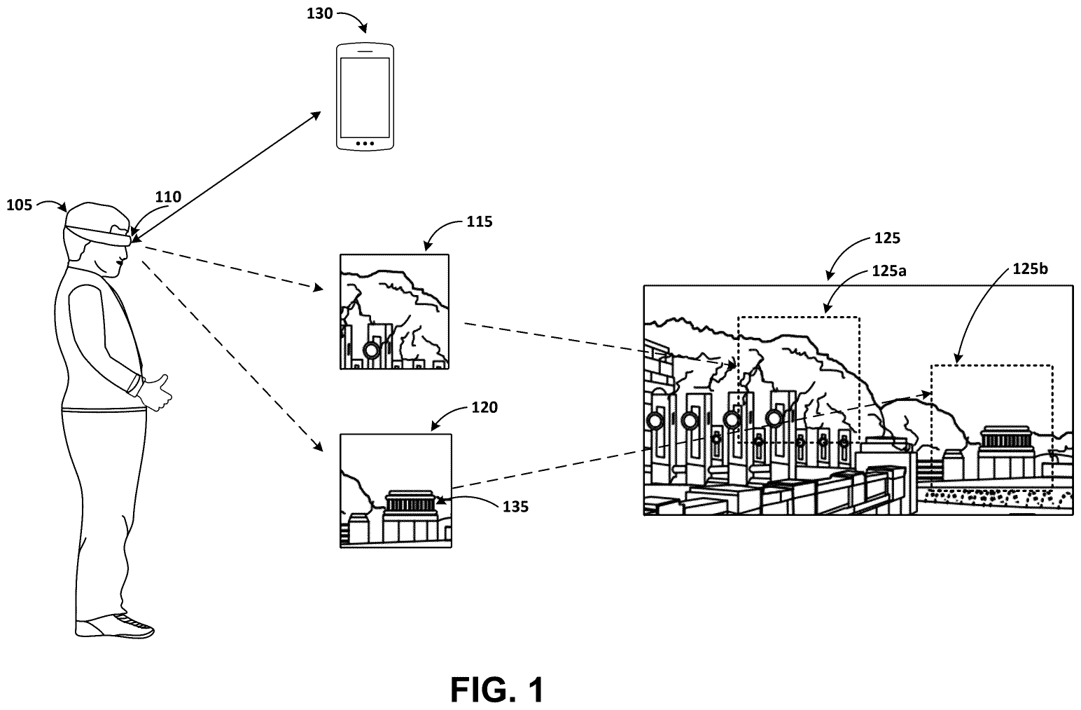

FIG. 1 illustrates a system for traversing a real-world environment using a map according to an example implementation. The system can be configured to use a SLAM system while traversing the real-world environment. The system can be configured to use bundle adjustment to optimize the SLAM system. The system can be configured to use keyframing in the bundle adjustment. The system can be configured to selectively modify landmarks during keyframing. The system can be configured to selectively choose images or keyframes to selectively modify landmarks. The system can be configured to selectively choose images or keyframes based on a timestamp to selectively modify landmarks. The timestamp can correspond to a time at which the image was captured by the device.

As shown in FIG. 1, the system includes a user 105, a device 110, and a companion device 130. Also shown in FIG. 1 is a first portion 125a of a real-world environment 125, a second portion 125b of the real-world environment 125. The device 110 can be configured to generate image data 115 representing the first portion 125a of the real-world environment 125 and image data 120 representing the second portion 125b of the real-world environment 125. The device 110 can be configured to generate pose data (sometimes referred to as inertial data) (not shown) representing movement of the device 110 and/or the user 105 from viewing the first portion 125a of the real-world environment 125 and viewing the second portion 125b of the real-world environment 125. Pose data can include position and orientation (pitch, yaw and roll) of the device 110.

The device 110 can be a wearable device. For example, device 110 can be a smart glasses device (e.g., AR glasses device), a head mounted display (HMD), a computing device, a wearable computing device, and the like. Device 110 can be a standalone movable device. For example, device 110 can be a robot, a drone, and the like. User 105 can be viewing a real-world view in any direction (note that standalone movable devices may not be worn by a user). The device 110 can be configured to generate an image of the real-world environment 125. The image data 115 representing the first portion 125a of the real-world environment 125 and image data 120 representing the second portion 125b of the real-world environment 125 can be generated based on the image. As mentioned above, an image can include a landmark. For example, image data 120 can include a landmark 135 (e.g., a building).

In some implementations, the device 110 can be configured to perform the processing described herein. However, the companion device 130 (e.g., a computing device, a mobile phone, a tablet, a laptop computer, and/or the like) can be configured to receive (e.g., via a wired and/or wireless connection) the image data 115, image data 120 representing, and/or the pose data. The image data 115, image data 120, and/or the pose data can be further processed by the companion device 130.

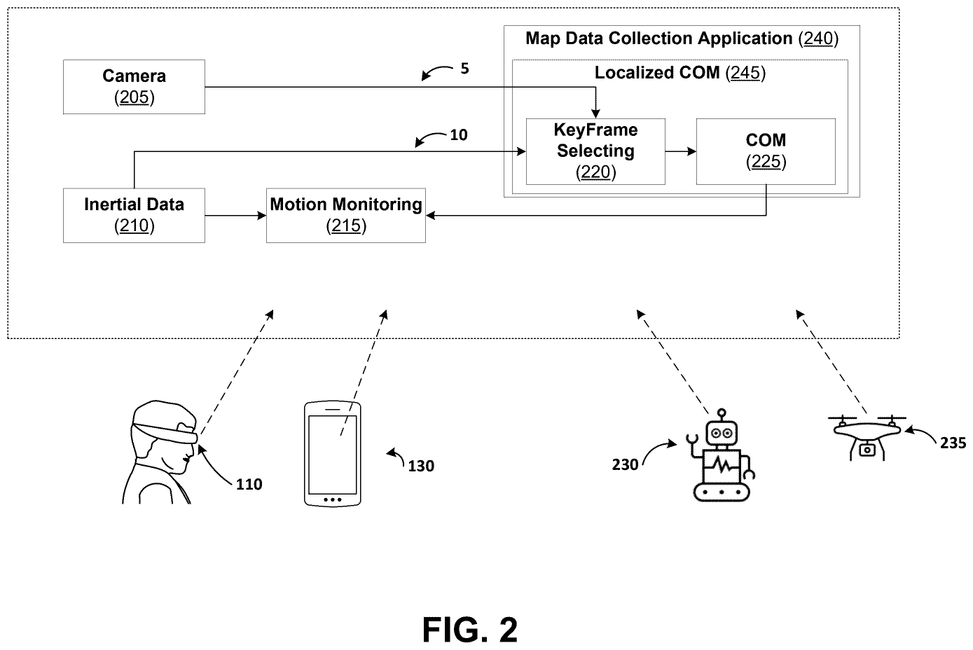

FIG. 2 illustrates a block diagram of a signal flow for bundle adjustment according to an example implementation. As shown in FIG. 2, the signal flow includes a camera 205 block, an inertial data 210 block, a motion monitoring 215 block, a keyframe selecting 220 block, and a COM 225 block. As shown in FIG. 2, device 110 can perform the signal flow. As shown in FIG. 2, companion device 130 can perform the signal flow. As shown in FIG. 2, a robot device 230 can perform the signal flow. As shown in FIG. 2, a drone device 235 can perform the signal flow. As shown in FIG. 2, device 110 and companion device 130 together can perform the signal flow. As shown in FIG. 2, robot device 230 and companion device 130 together can perform the signal flow. As shown in FIG. 2, drone device 235 and companion device 130 together can perform the signal flow. In some implementations, the device 110 (e.g., wearable device), companion device 130, robot device 230, and drone device 235 are just example devices. Other devices can perform the functions described herein.

As shown in FIG. 2, camera 205 can be configured to capture (e.g., sense, generate, and the like) image data (e.g., of the real-world environment 125, image data 115, image data 120, and/or the like). Camera 205 can be associated with (e.g., an element of) a device or computing device (e.g., device 110, robot device 230, drone device 235, and/or the like). In some implementations, camera 205 can be a forward-looking camera of the computing device (e.g., a wearable device). In some implementations, camera 205 can be configured to capture image data associated with, for example, a real-world environment and/or at least a portion of a real-world environment. The real-world environment can be associated with the direction and/or a pose of the device (e.g., device 110, robot device 230, drone device 235, and/or the like).

Inertial data 210 can be data associated with the movement of a device. For example, inertial data 210 can be used in a pose monitoring system associated with a device (e.g., device 110, robot device 230, drone device 235, and/or the like). Pose can include position and orientation (pitch, yaw and roll). Therefore, pose data can include position and orientation (pitch, yaw and roll) of the device. Pose monitoring can include the monitoring of position and orientation (pitch, yaw and roll) of the device 110. Therefore, inertial data can include data associated with 6DoF monitoring of the device. Inertial data can be associated with simultaneous localization and mapping (SLAM) and/or visual-inertial odometry (VIO).

Inertial data 210 can include, for example, data captured by an inertial measurement unit (IMU) of the device. In some implementations, inertial data 210 can further include calibration data (e.g., of motion devices), accelerometer data, gyroscope data, and in some cases magnetometer data. In some implementations, SLAM and/or VIO can also use other non-image data or auxiliary data including, for example, range sensor data, camera rolling shutter information, camera zooming information, and/or other sensor data. In some implementations, inertial data 210 can be generated and/or captured by a companion device (e.g., companion device 130). The motion monitoring 215 block can be configured to generate motion monitoring data based on inertial data 210. The motion monitoring data can correspond to movement of the device within, or relative to, the real-world environment or at least a portion of the real-world environment. The movement can represent movement of the device with respect to the real-world environment or at least a portion of the real-world environment.

Mapping a real-world environment can include using an application configured to provide instructions to a user of a device (e.g., AR/VR/MR device, a robot, and the like) during data collection, hereinafter referred to as a map data collection application 240. The map data collection application 240 can be used by software developers and content creators. The map data collection application 240 can be configured to generate (or help generate) three-dimensional (3D) content at real-world locations. The map data collection application 240 can be configured to guide a content creator to collect data (e.g., location data) when creating 3D content at a real-world location. The map data collection application 240 can be included in user software (e.g., for playback of the 3D content) to collect data (e.g., location data) when a user of a device (e.g., AR/VR/MR device, a robot, and the like) is using the software including the application in the associated real-world location. The provided instructions can ensure that all spaces are covered, and the data is sufficient for creating a high-quality feature map.

Some map data collection applications can be configured to use a pose graph system (PGS) for monitoring device motion. A PGS can be configured to use images (or other camera data), positioning sensor measurements (e.g., global positioning sensors (GPS), inertial measurement unit (IMU) data, and/or the like) for device (e.g., AR/VR/MR device, a robot, and the like) position and/or motion monitoring. Some implementations can remove the PGS to improve the map data collection application performance. For example, one option is to replace the PGS with a concurrent odometry and mapping system (COM), COM 225, which is developed for motion monitoring. Some implementations use COM 225 for high-precision, room/house-scale VR/AR applications. Some implementations use COM 225 in map data collection application 240.

For example, referring to FIG. 2, device 110 (e.g., AR/VR/MR device, a robot, and the like) can include a COM 225 to monitor the motion of the device. COM 225 can monitor motion based on image sensor data 5 and non-image sensor data 10. COM 225 can be configured to generate a three-dimensional representation of a local environment (e.g., real-world environment 125). COM 225 can periodically update the three-dimensional representation of the local environment with feature descriptors generated based on the image sensor data 5 and the non-visual sensor data 10. COM 225 can use the updated three-dimensional representation of the local environment to correct for drift and other pose errors associated with motion monitoring 215. In other words, COM 225 can use the updated three-dimensional representation of the local environment to cause a refining of an error correction associated with determining a motion of the device. Pose errors can include errors in determining or estimating pose data. Therefore, pose errors can include errors in determining or estimating position and orientation (pitch, yaw and roll) of the device.

COM 225 can be configured to generate estimated poses (e.g., motion) of the device at a high rate based on the image sensor data 5 and the non-image sensor data 10 for output to an API (not shown). COM 225 can generate feature descriptors based on image sensor data 5 and non-visual sensor data 10. COM 225 can store a plurality of maps including known feature descriptors, from which COM 225 can build a three-dimensional representation of the local environment. COM 225 can use the known feature descriptors to map the local environment. For example, COM 225 can use the known feature descriptors to generate a map file that indicates the position of each feature included in the known feature descriptors in a frame of reference for the device. As COM 225 generates new feature descriptors based on image sensor data 5 and non-visual sensor data 10, COM 225 can periodically augment the three-dimensional representation of the local environment by matching the generated feature descriptors to the known feature descriptors.

COM 225 can use the three-dimensional representation of the environment to periodically correct drift associated with motion monitoring 215. Accordingly, COM 225 can generate locally-accurate estimated pose data for output to the API at a relatively high frequency. COM 225 can periodically correct global drift in the estimated pose data to generate a localized pose using the three-dimensional representation of the local environment. The estimated and localized poses can be used to support any of a variety of location-based services. For example, in some implementations the estimated and localized poses can be used to generate a virtual reality environment, an augmented reality environment, or portion thereof, representing the local environment of the electronic device. In some implementations, COM 225 can be configured to monitor motion (estimate a pose) at a first, relatively higher rate, and to update a map of the environment to be used to localize the estimated pose data at a second, relatively lower rate.

COM 225 may not be applicable for large-scale environments (e.g., multi-story buildings). Therefore, some implementations can include an extension of COM 225 which may require lower processing resources and memory consumption. The extension of COM 225 may be referred to herein as a localized concurrent odometry and mapping system or localized COM 245. Localized COM 245 can be configured to accurately monitor device motion over a long period of time. Further, some implementations can include an interface configured to support the functionalities of the map data collection application. The interface can be an Application Programming Interface (API). Localized COM 245 can include COM 225 and keyframe selecting 220. In some implementations, the map data collection application 240 can include COM 225 and/or localized COM 245.

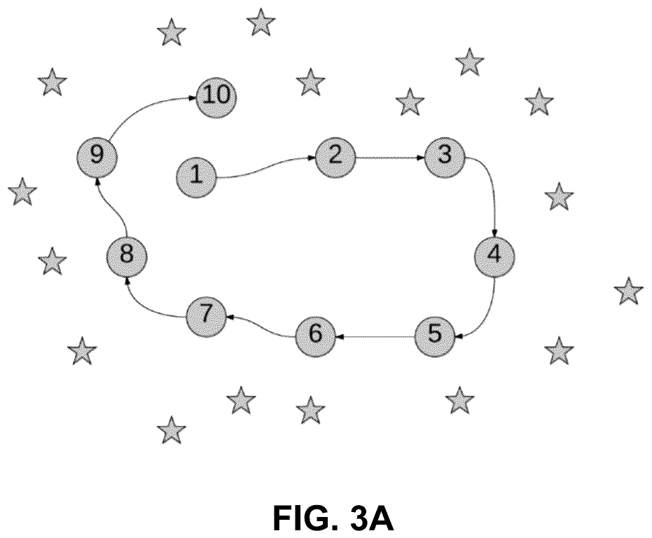

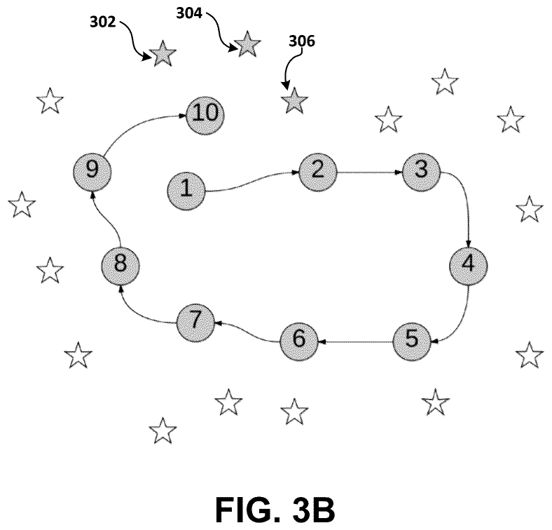

FIG. 3A illustrates a plurality of circles that denote device poses from a starting time instant 1 to a current time instant 10. FIG. 3A further illustrates a plurality of stars that represent the observed landmarks along the motion from time instant 1 to time instant 10.

Equation 1 is an optimization problem that estimates all the device poses, x, and observed landmarks, f, for a COM implementation.

x,f=argmin∥g(x)∥²+∥h(x,f)∥² (1)
where,
g(x) is the cost term arising from IMU measurements, and
h(x, f) is the cost term arising from camera measurements.

Note that the number of variables in COM can grow quickly when the device is in motion. Therefore, the processing and memory required to solve COM can become resource intensive after a period of time.

FIG. 3B illustrates a plurality of circles that denote device poses from a starting time instant 1 to a current time instant 10. FIG. 3B further illustrates a plurality of stars that represent the observed landmarks along the motion from time instant 1 to time instant 10. In FIG. 3B some of the stars are shaded and some are not shaded. The shaded stars 302, 304, 306 can represent surrounding landmarks, along with the device poses, which are represented as circles.

Equation 2 is an optimization problem that estimates all the device poses, x, and observed surrounding landmarks, f_{sub}, for a localized COM implementation.

x,f_{sub}=argmin∥g(x)∥²+∥h(x,f)∥² (2)
where,
g(x) is the cost term arising from IMU measurements, and
h(x, f) is the cost term arising from camera measurements.

Note that for the localized COM implementation (1) the localized COM implementation does not drop any visual/inertial measurements. In other words, the cost function stays the same; and (2) the localized COM implementation optimizes over a small subset of landmarks, f_{sub}, that are currently observed. The number of landmarks f is typically much larger than the number of poses of the device x in COM. Therefore, using the small subset of landmarks, f_{sub}, reduces the problem size.

The localized COM implementation, represented by equation 2, can (1) optimize over all surrounding landmarks, so as to make sure a high-quality local map is created for motion monitoring (e.g., motion monitoring 215). On the other hand, in order to reduce the processing and memory costs, other landmarks are assumed to be constant. The localized COM implementation can (2) estimate the device poses from the start of service to the current moment, and thus is able to properly close the trajectory loop when detecting global-loop-closure (GLC) measurements. The localized COM implementation can, (3) since all the landmarks are defined with respect to their first observing device pose, correcting errors in the device poses also automatically fixes the landmark global position.

Returning to FIG. 2, when applied to map data collection application 240, the localized COM 245 implementation can be further sped up by foregoing creation of any new map during the open-loop exploration by the backend. In other words, a new map is created only if a global loop-closure is detected. A global loop-closure can indicate that the device has traversed around a landmark. The processing time of localized COM 245 implementation can be reduced by keyframe selecting 220. Keyframe selecting 220 can be configured to restrict a keyframe selection criterion and/or criteria. Keyframe selecting 220 can be configured to reduce the number of keyframes kept in the mapping by restricting the keyframe selection criterion and/or criteria. The localized COM 245 implementation can be further sped up without noticeably reducing performance. In operation, COM 225 can operate in a non-localized implementation by setting keyframe selecting 220 to select all, most, or substantially all keyframes.

Localized COM 245 implementation can reduce resource (e.g., processor and memory) usage as compared to COM 225. In some implementations, the resource usage reduction of localized COM 245 as compared to COM 225 can increase with the problem size. For example, if only a very small portion of the landmarks are observed in surroundings, the localized COM 245 implementation computation savings can be large.

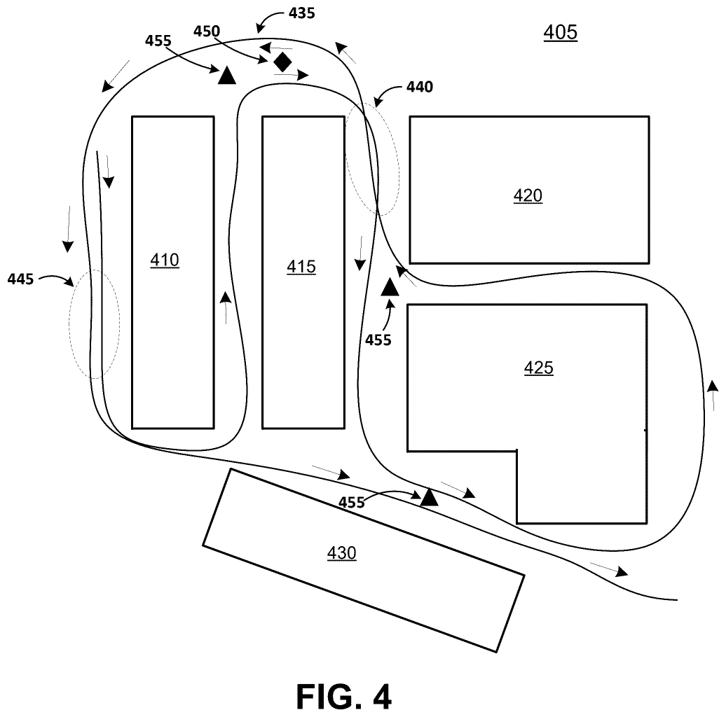

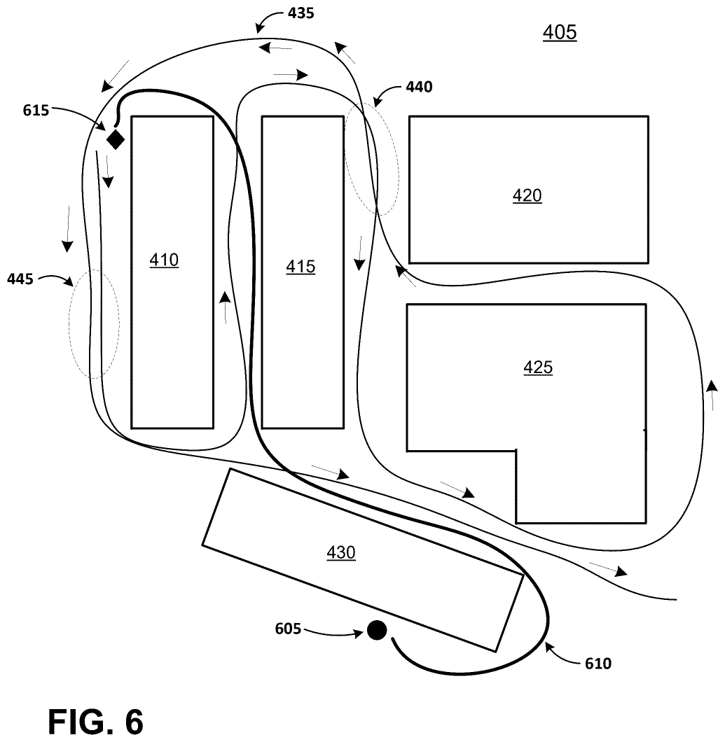

Collecting data during a map creation phase, e.g., using the map data collection application 240, can include two phases. FIG. 4 illustrates the first phase sometimes referred to as location learning according to at least one example implementation. Shown in FIG. 4 is a trajectory covering a real-world environment. FIG. 6 illustrates the second phase sometimes referred to as feature dataset recording. In FIG. 6, 605 represents a beginning or start location of a device trajectory or traversal and 615 represents an end, stop, or current location of the device trajectory or traversal. Shown in FIG. 6 is a collection of sufficient data following the building skeletons determined in the first phase or FIG. 4.

In FIGS. 4 and 6, a real-world environment 405 (e.g., the real-world environment 125) includes a plurality of structures 410, 415, 420, 425, 430, can form paths through which a device (e.g., device 110) can travel. Trajectory 435 can represent a travelled path. Arrows along trajectory 435 can represent a direction of travel associated with the device. Path portion 440, 445 represent duplicated device travel or a path through which the device travelled two or more times. In the example of FIGS. 4 and 6, path portion 440 can represent duplicated device travel where the device travelled in both directions through the path. In the example of FIGS. 4 and 6, path portion 445 can represent duplicated device travel where the device travelled in one (or the same) direction through the path.

Location 450 can represent the current location of the device. In the example of FIG. 4, location 450 can be along a duplicated device travel path (note the direction arrows are in opposite directions). Location(s) 455 can represent a location where a loop has been closed. A loop-closure can indicate that the device has traversed around a landmark. In other words, location(s) 455 can represent a location where the device has travelled such that the path around at least one of the plurality of structures 410, 415, 420, 425, 430 has been closed. In other words, location(s) 455 can represent a location where the device circuited a path around at least one of the plurality of structures 410, 415, 420, 425, 430.

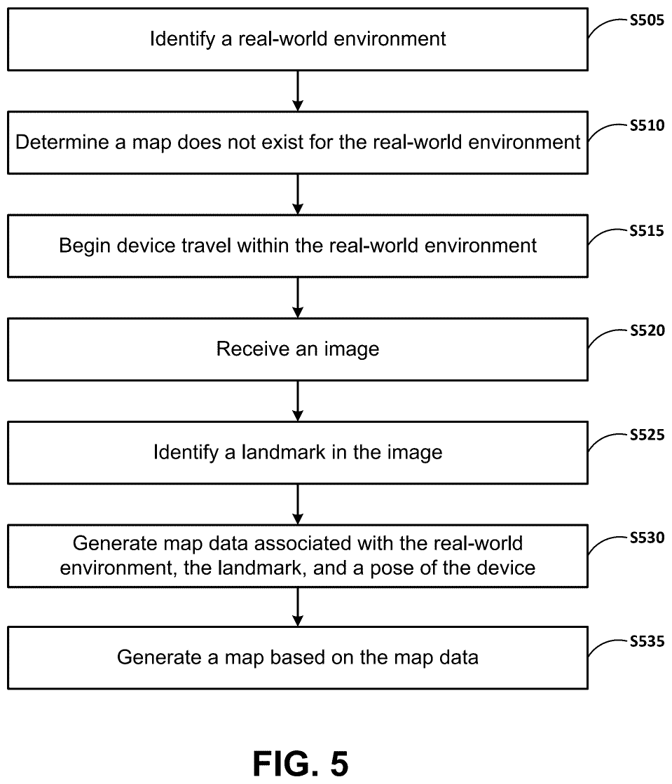

FIG. 5 illustrates a block diagram of a method for location learning according to at least one example implementation. FIG. 5 illustrates a block diagram of a method for location learning corresponding to trajectory 435 of FIG. 4. As shown in FIG. 5, in step S505, identify a real-world environment. For example, the real-world environment can be associated with the location of a device (e.g., device 110). The location can correspond to a global positioning system (GPS) location. The location can correspond to a coordinate system location. The location can correspond to an address. The location can correspond to a custom (e.g., developer generated) location. The location can be an outdoors location. The location can be an indoor location. The location can correspond to a floor in a building. The location can correspond to a room in a building. The location can correspond to a region in a building. These are just a few examples for a location that can have an associated map.

In step S510 a device can determine a map does not exist for the real-world environment. A map can be a portion of a larger map. The map can be stored in a memory as map data. The map can be stored in the device. The map can be stored in a computing device (e.g., server) communicatively coupled to the device. The map can be stored in a companion device (e.g., a proximate computing device communicatively coupled to the device). Therefore, determining that the map does not exist (or whether or not the map exists) can include searching the memory for the map based on, for example, the location corresponding to the real-world environment. If no results are returned for the search, the map does not exist. If a result is returned for the search, the map exists.

In step S515 begin device travel within the real-world environment. For example, if the device is a wearable device (e.g., device 110), the user of the device can begin moving in the real-world environment. For example, if the device is a robot (e.g., robot device 230), the robot can begin moving in the real-world environment. For example, a robot can receive an instruction to move within the real-world environment. For example, if the device is a drone (e.g., drone device 235), the drone can begin moving in the real-world environment. For example, a drone can receive an instruction to move within the real-world environment.

In step S520 receive an image. The device can be configured to capture an image. For example, the device can include a camera(s) (e.g., a forward-facing camera) configured to capture (or sense) an image(s). The device can be configured to capture a plurality of images. The device can be configured to capture a plurality of sequential (e.g., in time) images. Similar to a video, each image of the plurality of images can be referred to as a frame. A portion of the plurality of images can be received. For example, one of the plurality of images can be received on a regular basis. For example, one of the plurality of images can be received on a predefined schedule. For example, one of every n (e.g., a predefined number) images of the plurality of images can be received. In some implementations, the received image can be referred to as a keyframe. In some implementations, the image can be received by a map data collection application (e.g., map data collection application 240). In some implementations, the image can be received by a map or mapping application. In some implementations, the image can be received by a SLAM application. In some implementations, the image can be received by a map data collection application (e.g., map data collection application 240).

In step S525 identify a landmark in the image. A landmark can be an object within the image. A landmark can be a point or patch on an object within the image. A landmark can be identified using a descriptor. For example, an object and/or a point on an object can have an associated descriptor identifying the object and/or point on the object as a landmark. The landmark can be identified using an object detection function. The landmark can be identified using an object detection model. The landmark can be identified using an object detection neural network. The landmark can be identified using an object identification function. The landmark can be identified using an object identification model. The landmark can be identified using an object identification neural network. The landmark can be identified using a model trained to identify objects in an image. The landmark can be a stationary object. The landmark can be a substantially stationary object. The landmark can be an object that infrequently moves. The landmark can be an object that is fixed at a location within the real-world environment. For example, the landmark can be a desk, a building, a wall, a tree, and the like. However, a landmark may not be a car, a person, an animal, and the like. In other words, a landmark may not be an object that moves often.

In step S530 the device can generate map data associated with the real-world environment, the landmark, and a pose of the device. In some implementations, the pose of the device can be a position and orientation (pitch, yaw and roll) of the device at the time the image was captured. The pose of the device can be detected using IMU data. Pose data of the device can be and/or include IMU data. In some implementations, IMU data (e.g., inertial data 210), calibration data (e.g., of motion devices), range sensor data, camera rolling shutter information, camera zooming information, and/or other sensor data. In some implementations, IMU data can be generated and/or captured by a companion device (e.g., companion device 130). Generating map data can include storing data representing the real-world environment, the landmark, and the pose of the device in a data structure. Generating map data can include linking and/or mapping data representing the real-world environment, the landmark, and the pose of the device in a data structure.

In step S535 the device can generate a map based on the map data. In some implementations, the map data can be stored as instances of data representing the real-world environment, the landmark, and the pose of the device. However, a map can include large quantities of the instances of data representing the real-world environment, the landmark, and the pose of the device. In some implementations, generating map data can include joining the instances of data in memory. In some implementations, generating map data can include converting the instances of data into a format associated with a map. For example, generating map data can include converting the instances of data into a format used by SLAM. For example, generating map data can include converting the instances of data into a visual format. For example, generating map data can include converting the instances of data into a mesh format that can be used to visually render a map.

In some implementations, steps S520, S525, and S530 can continue in a processing loop while the device travels within the real-world environment. In some implementations, step S535 can be performed while the device travels within the real-world environment. In some implementations, step S535 can be performed after the device stops traveling within the real-world environment.

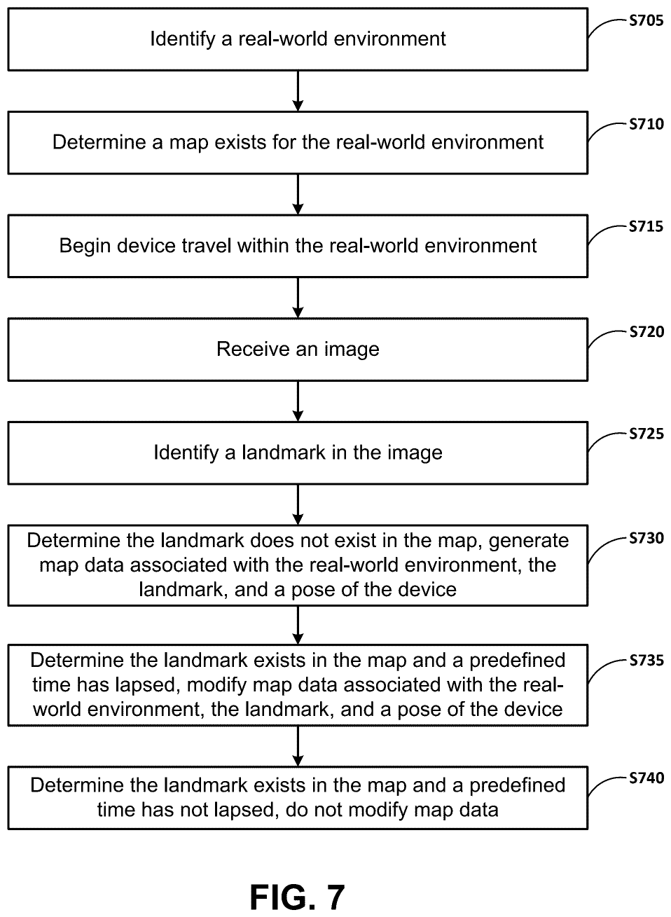

FIG. 7 illustrates a block diagram of a method for feature dataset recording according to at least one example implementation. FIG. 7 illustrates a block diagram of a method for feature dataset recording corresponding to trajectory 610 of FIG. 6. In FIG. 6, 605 represents the beginning or start location of a device associated with trajectory 610 and 615 represents an end, stop, or current location of the device associated with trajectory 610. As shown in FIG. 7, in step S705 identify a real-world environment. For example, the real-world environment can be associated with the location of a device (e.g., device 110). The location can correspond to a global positioning system (GPS) location. The location can correspond to a coordinate system location. The location can correspond to an address. The location can correspond to a custom (e.g., developer generated) location. The location can be an outdoors location. The location can be an indoor location. The location can correspond to a floor in a building. The location can correspond to a room in a building. The location can correspond to a region in a building. These are just a few examples for a location that can have an associated map.

In step S710 the device determines a map exists for the real-world environment. A map can be a portion of a larger map. The map can be stored in a memory as map data. The map can be stored in the device. The map can be stored in a computing device (e.g., server) communicatively coupled to the device. The map can be stored in a companion device (e.g., a proximate computing device communicatively coupled to the device). Therefore, determining that the map exists (or whether or not the map exists) can include searching the memory for the map based on, for example, the location corresponding to the real-world environment. If a result is returned for the search, the map exists. If no results are returned for the search, the map does not exist.

In step S715 begin device travel within the real-world environment. For example, if the device is a wearable device (e.g., device 110), the user of the device can begin moving in the real-world environment. For example, if the device is a robot (e.g., robot device 230), the robot can begin moving in the real-world environment. For example, the robot can receive an instruction to move within the real-world environment. For example, if the device is a drone (e.g., drone device 235), the drone can begin moving in the real-world environment. For example, the drone can receive an instruction to move within the real-world environment.

In step S720 receive an image. The device can be configured to capture an image. For example, the device can include a camera(s) (e.g., a forward-facing camera) configured to capture (or sense) an image(s). The device can be configured to capture a plurality of images. The device can be configured to capture a plurality of sequential (e.g., in time) images. Similar to a video, each image of the plurality of images can be referred to as a frame. A portion of the plurality of images can be received. For example, one of the plurality of images can be received on a regular basis. For example, one of the plurality of images can be received on a predefined schedule. For example, one of every n (e.g., a predefined number) images of the plurality of images can be received. In some implementations, the received image can be referred to as a keyframe. In some implementations, the image can be received by a map data collection application (e.g., map data collection application 240). In some implementations, the image can be received by a map or mapping application. In some implementations, the image can be received by a SLAM application. In some implementations, the image can be received by a map data collection application (e.g., map data collection application 240).

In step S725 identify a landmark in the image. A landmark can be an object within the image. The landmark can be identified using an object detection function. The landmark can be identified using an object detection model. The landmark can be identified using an object detection neural network. The landmark can be identified using an object identification function. The landmark can be identified using an object identification model. The landmark can be identified using an object identification neural network. The landmark can be identified using a model trained to identify objects in an image. The landmark can be a stationary object. The landmark can be a substantially stationary object. The landmark can be an object that infrequently moves. The landmark can be an object that is fixed at a location within the real-world environment. For example, the landmark can be a desk, a building, a wall, a tree, and the like. However, a landmark may not be a car, a person, an animal, and the like. In other words, a landmark may not be an object that moves often.

In step S730 the device determines the landmark does not exist in the map (and/or in the map data), generate map data associated with the real-world environment, the landmark, and a pose of the device. As mentioned above, generating map data can include storing data associated with a landmark. Therefore, determining whether or not the landmark exists can include searching the map and/or map data based on the landmark. If a result is returned for the search, the landmark exists in the map and/or map data. If no results are returned for the search, the landmark does not exist in the map and/or map data.

In some implementations, the pose of the device (e.g., pose data) can be an orientation of the device at the time the image was captured. The pose of the device can be detected using IMU data. The pose of the device can be and/or include IMU data. In some implementations, IMU data (e.g., inertial data 210), calibration data (e.g., of motion devices), range sensor data, camera rolling shutter information, camera zooming information, and/or other sensor data. In some implementations, IMU data can be generated and/or captured by a companion device (e.g., companion device 130). Generating map data can include storing data representing the real-world environment, the landmark, and the pose of the device in a data structure. Generating map data can include linking and/or mapping data representing the real-world environment, the landmark, and the pose of the device in a data structure.

In step S735 the device determines the landmark exists in the map (and/or in the map data) and a predefined time has lapsed, modify map data associated with the real-world environment, the landmark, and a pose of the device. As mentioned above, generating map data can include storing data associated with a landmark. Therefore, determining whether or not the landmark exists can include searching the map and/or map data based on the landmark. If a result is returned for the search, the landmark exists in the map and/or map data. If no results are returned for the search, the landmark does not exist in the map and/or map data. The predefined time can be long enough to ensure that data is not modified unnecessarily. The predefined time can be short enough to ensure that data is accurate. The predefined time can correspond to a criterion and/or criteria. The criterion and/or criteria can be based on the timestamp. The criterion and/or criteria can be based on the timestamp being older than some time threshold. Modifying map data can include updating and/or changing the landmark associated with the real-world environment (e.g., location). Modifying map data can include updating and/or changing the pose of the device associated with the landmark (e.g., the object associated with the real-world environment (e.g., location)).

In step S740 determine the landmark exists in the map (and/or in the map data) and a predefined time has not lapsed, do not modify map data. In other words, the map is considered accurate for the landmark in the real-world environment. Therefore, modifying the map has no benefit. Therefore, processing resources can be conserved by not modifying the map.

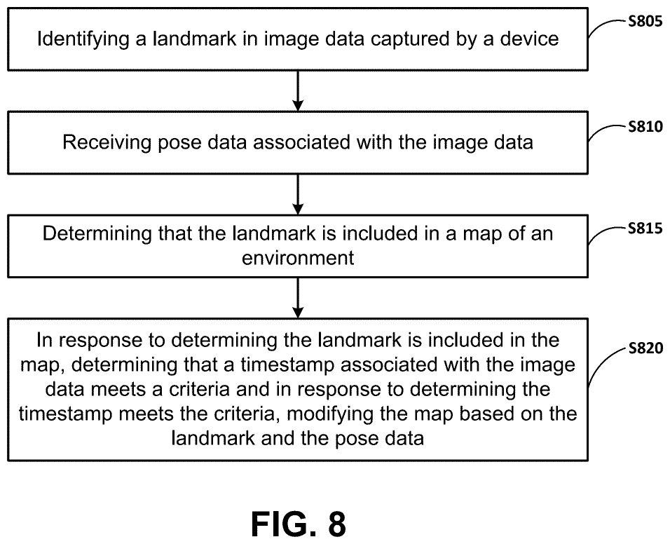

Example 1. FIG. 8 is a block diagram of a method modifying a map of an environment according to an example implementation. As shown in FIG. 8, in step S805 identifying a landmark in image data (e.g., data representing an image) captured by a device. In step S810 receiving pose data associated with the image data. In step S815 determining that the landmark is included in a map of an environment. In step S820, in response to determining that the landmark is included in the map, determining that a timestamp associated with the image data meets a criterion and/or criteria, and in response to the device determining that the timestamp meets the criterion and/or criteria, modifying the map based on the landmark and the pose data. The timestamp can correspond to a time at which the image was captured by the device.

Example 2. The method of Example 1 can further include capturing multiple images by the device, wherein the multiple images including the landmark and the image data includes data from the multiple images and discarding image data from an image of the multiple images as discarded image data based on a timestamp associated with the image.

Example 3. The method of Example 1, wherein the identifying of the landmark can include identifying a plurality of landmarks and the method can further include determining (e.g., tracking or monitoring) a motion of the device using the plurality of landmarks and the pose data, selecting a subset of the plurality of landmarks, the subset including landmarks surrounding a location of the device, and in response to determining the timestamp meets the criterion and/or criteria, modifying the map based on the subset of the plurality of landmarks and the pose data.

Example 4. The method of Example 1 can further include in response to determining the timestamp meets the criterion and/or criteria, refining an error correction associated with determining a motion of the device.

Example 5. The method of Example 1, wherein the criterion and/or criteria can be a time greater than a threshold.

Example 6. The method of Example 1, wherein the map can include data associated with the environment, data associated with the landmark, and the pose data.

Example 7. The method of Example 1, wherein in response to determining the landmark is not included in the map, the method can further include generating map data based on the environment, data associated with the landmark, and the pose data and including the map data in the map.

Example 8. The method of Example 1, wherein the device can be one of a wearable device, a robot device, or a drone device.

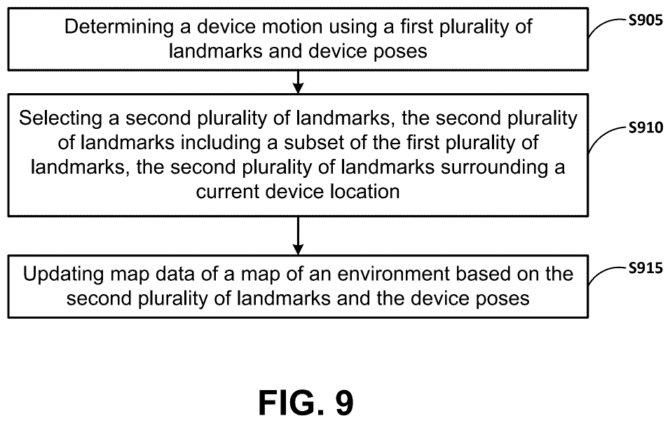

Example 9. FIG. 9 is a block diagram of a method modifying a map of an environment according to an example implementation. As shown in FIG. 9, in step S905 determining a device motion using a first plurality of landmarks and device poses. In step S910 selecting a second plurality of landmarks, the second plurality of landmarks including a subset of the first plurality of landmarks, the second plurality of landmarks surrounding a current device location. In step S915 updating map data of a map of an environment based on the second plurality of landmarks and the device poses.

Example 10. The method of Example 9 can further include obtaining image data from multiple images captured by the device, the image data including data corresponding to the first plurality of landmarks, selecting an image of the multiple images based on a timestamp associated with the image, and using the selected image to determine the device motion.

Example 11. The method of Example 9 can further include obtaining image data from multiple images captured by the device, the image data including data corresponding to the first plurality of landmarks and discarding image data of the multiple images based on a timestamp associated with the image.

Example 12. The method of Example 9 can further include determining at least one landmark of the second plurality of landmarks is not included in the map, generating the map data based on a location of the device, data associated with the at least one landmark surrounding the current device location is not included in the map, and the device poses, and including the map data in the map.

Example 13. The method of Example 9 can further include refining an error correction associated with the determining of the device motion.

Example 14. The method of Example 9, wherein the device can be one of a wearable device, a robot device, or a drone device.

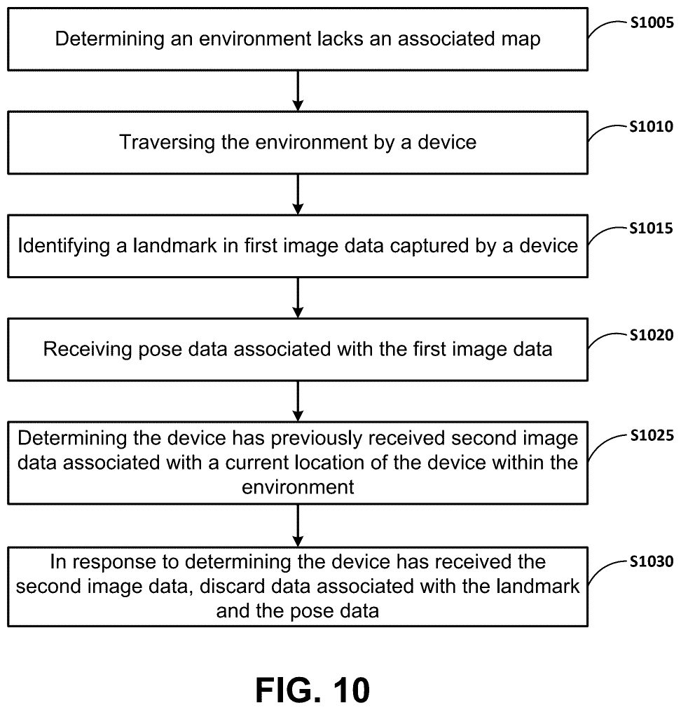

Example 15. FIG. 10 is a block diagram of a method generating a map of an environment according to an example implementation. As shown in FIG. 10, in step S1005 determining an environment lacks an associated map. In step S1010 traversing the environment by a device. In step S1015 identifying a landmark in first image data captured by a device. In step S1020 receiving pose data associated with the first image data. In step S1025 determining the device has previously received second image data associated with a current location of the device within the environment. In step S1030 in response to determining the device has received the second image data, discard data associated with the landmark and the pose data.

Example 16. The method of Example 15 can further include in response to determining the device has received the second image data, generating map data based on the environment, data associated with the landmark, and the pose data, and generating the map based on the map data.

Example 17. The method of Example 15, wherein the determining the device has received the second image data can be based on the device traversing around the landmark k and the method can further include generating the map in response to determining the device is traversing around the landmark.

Example 18. The method of Example 15, wherein the determining the device has received the second image data can be based on the device traversing by the landmark in a same direction.

Example 19. The method of Example 15, wherein the the determining the device has received the second image data can be based on the device traversing by the landmark in a different direction.

Example 20. The method of Example 15, wherein the device can be one of a wearable device, a robot device, or a drone device.

Example 21. A method can include any combination of one or more of Example 1 to Example 20.

Example 22. A non-transitory computer-readable storage medium comprising instructions stored thereon that, when executed by at least one processor, are configured to cause a computing system to perform the method of any of Examples 1-21.

Example 23. An apparatus comprising means for performing the method of any of Examples 1-21.

Example 24. An apparatus comprising at least one processor and at least one memory including computer program code, the at least one memory and the computer program code configured to, with the at least one processor, cause the apparatus at least to perform the method of any of Examples 1-21.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computing device having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, may be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

What is claimed is:

1. A method comprising:
identifying a landmark in image data captured by a device;
receiving pose data associated with the image data;
determining that the landmark is included in a map of an environment; and
in response to determining that the landmark is included in the map,
determining that a timestamp associated with the image data meets a criterion, and
in response to determining the timestamp meets the criterion, modifying the map based on the landmark and the pose data.

2. The method of claim 1, further comprising:
capturing multiple images by the device, wherein the multiple images including the landmark and the image data includes data from the multiple images; and
discarding image data from an image of the multiple images as discarded image data based on a timestamp associated with the image.

3. The method of claim 1, wherein identifying the landmark includes identifying a plurality of landmarks, the method further comprising:
determining a motion of the device using the plurality of landmarks and the pose data;
selecting a subset of the plurality of landmarks, the subset including landmarks surrounding a location of the device; and
in response to determining the timestamp meets the criterion, modifying the map based on the subset of the plurality of landmarks and the pose data.

4. The method of claim 1, further comprising:
in response to determining the timestamp meets the criterion, refining an error correction associated with determining a motion of the device.

5. The method of claim 1, wherein
the criterion is a time greater than a threshold.

6. The method of claim 1, wherein the map includes data associated with the environment, data associated with the landmark, and the pose data.

7. The method of claim 1, wherein in response to determining the landmark is not included in the map, the method further comprising:
generating map data based on the environment, data associated with the landmark, and the pose data; and
including the map data in the map.

8. The method of claim 1, wherein the device is one of a wearable device, a robot device, or a drone device.

9. A method comprising:
determining a device motion using a first plurality of landmarks and device poses;
selecting a second plurality of landmarks, the second plurality of landmarks including a subset of the first plurality of landmarks, the second plurality of landmarks surrounding a current device location; and
updating map data of a map of an environment based on the second plurality of landmarks and the device poses.

10. The method of claim 9, further comprising:
obtaining image data from multiple images captured by the device, the image data including data corresponding to the first plurality of landmarks;
selecting an image of the multiple images based on a timestamp associated with the image; and
using the selected image to determine the device motion.

11. The method of claim 9, further comprising:
obtaining image data from multiple images captured by the device, the image data including data corresponding to the first plurality of landmarks; and
discarding image data of the multiple images based on a timestamp associated with the image.

12. The method of claim 9, further comprising:
determining at least one landmark of the second plurality of landmarks is not included in the map;
generating the map data based on a location of the device, data associated with the at least one landmark surrounding the current device location is not included in the map, and the device poses; and
including the map data in the map.

13. The method of claim 9, further comprising refining an error correction associated with the determining of the device motion.

14. The method of claim 9, wherein the device is one of a wearable device, a robot device, or a drone device.

15. A method comprising:
determining an environment lacks an associated map;
traversing the environment by a device;
identifying a landmark in first image data captured by a device;
receiving pose data associated with the first image data;
determining the device has previously received second image data associated with a current location of the device within the environment; and
in response to determining the device has received the second image data, discard data associated with the landmark and the pose data.

16. The method of claim 15, further comprising:
in response to determining the device has received the second image data,
generating map data based on the environment, data associated with the landmark, and the pose data, and
generating the map based on the map data.

17. The method of claim 15, wherein the determining the device has received the second image data is based on the device traversing around the landmark and the method can further comprise generating the map in response to determining the device is traversing around the landmark.

18. The method of claim 15, wherein the determining the device has received the second image data is based on the device traversing by the landmark in a same direction.

19. The method of claim 15, wherein the determining the device has received the second image data is based on the device traversing by the landmark in a different direction.

20. The method of claim 15, wherein the device is one of a wearable device, a robot device, or a drone device.
